(19) United States
(12) Patent Application Publication
(10) Pub. No.: US 2020/0200489 A1
(43) Pub. Date: Jun. 25, 2020

(54) TUBE FOR A HEAT EXCHANGER AND METHOD OF MAKING THE TUBE

(71) Applicant: MAHLE International GmbH, Stuttgart (DE)

(72) Inventor: David L. McDermott, Commerce Township, MI (US)

(73) Assignee: MAHLE International GmbH

(21) Appl. No.: 16/225,732

(22) Filed: Dec. 19, 2018

(51) Int. Cl. F28F 1/02; F28F 1/42; F28F 1/06

(52) U.S. Cl. CPC F28F 1/022; B82Y 40/00; F28F 1/06; F28F 1/422

(57) ABSTRACT

A tube for a heat exchanger core bears a micro texture imprinted on an outer surface of the tube. The micro texture having depth of 0.01 mm to 0.03 mm and is thus hardly visible by a naked eye. When the tube is made of cladded metal strip material, the micro texture may have a depth that may be slightly greater than the thickness of the cladding. For folded tubes, an entire strip surface may be covered with the micro texture so that micro texture is present on the outer surface of tube and inside tube. Alternatively, the micro texture may be imprinted after forming the tube so that the micro texture is only present on the outer surface of the tube.

### TECHNICAL FIELD

The present invention relates generally to a method of fabricating a tube for a heat exchanger, to a tube fabricated according to the method, and to a heat exchanger comprising such a tube.

### BACKGROUND

A heat exchanger assembly such as a radiator, condenser, or evaporator for use in a motor vehicle typically includes an inlet header, an outlet header, and possibly a transitional header in-between so that the inlet header and outlet header may be disposed side-by-side. A heat exchanger core contains a plurality of tubes hydraulically connecting the headers for fluid flow therebetween and external corrugated fins interconnecting the tubes. The headers, tubes, and fins are typically assembled into a unitary structure and brazed to form the heat exchanger assembly.

A first heat transfer fluid, such as a liquid coolant, flows from the inlet header to the outlet header through the plurality of tubes. The first heat transfer fluid is in contact with the interior surfaces of the tubes while a second heat transfer fluid, such as ambient air, is in contact with the exterior surfaces of the tubes and with the corrugated fins. Where a temperature difference exists between the first and second fluids, heat is transferred from the higher temperature fluid to the lower temperature fluid through the walls of the tubes.

The tubes that connect the headers are typically formed from sheet metal and may be formed by welding or folding. For example, a flat elongated sheet of metallic material is folded to form a tube having multiple ports defined by internal corrugated folds. The internal corrugated folds form the internal webs that define the shape and size of the ports.

Such a tube geometry can also be achieved by extrusion. However, folded tubes provide several advantages over extruded tubes in terms of lower cost and ease of manufacturing for the tube itself as well as for the final assembly of the heat exchanger. One significant advantage is that a folded tube can be formed from a sheet of clad aluminum that offers superior corrosion resistance without the need for applying additional coatings. Extrusion technology cannot readily create tubes with external clad layer and hence to achieve equivalent corrosion resistance, a separate coating operation is required which increases cost and also which is not environmentally benign. Another advantage is that due to the presence of cladding on the tube, other components of the heat exchanger, such as the headers and air fins, need not be cladded, thereby simplifying the material system for corrosion protection. A further advantage is that since the headers do not need to be cladded, the headers can be formed with extrusion technology to reduce the cost of manufacturing.

At times, however, providing a leak-proof connection between the tubes and the respective header proves to be difficult due to challenges presented in the brazing process. If the brazing connection is imperfect, leaks become apparent during the operation of the heat exchanger, especially due to the high temperature variations incurred by the heat exchanger.

It is thus desirable to improve the brazing connection between the tubes and the heat exchanger.

### SUMMARY OF THE INVENTION

In accordance with one aspect of the present disclosure, a tube for a heat exchanger core bears a micro texture imprinted on an outer surface of the tube. The micro texture having depth of 0.01 mm to 0.03 mm and is thus hardly visible by a naked eye.

When the tube is made of cladded metal strip material, the micro texture may have a depth that may be slightly greater than the thickness of the cladding. For folded tubes, an entire strip surface may be covered with the micro texture so that micro texture is present on the outer surface of tube and inside tube.

Alternatively, the micro texture may be imprinted after forming the tube so that the micro texture is only present on the outer surface of the tube.

The micro texture may only be imprinted as textured bands proximate the ends of the tube within 10 mm of tube ends, with central portion between texture bands being free of micro texture. In particular for tubes having winglets, the winglets may be imprinted between the textured bands.

The micro texture may be an imprinted pattern forming capillary channels. For enhancing the flow of the melted cladding material during brazing, the capillary channels may be interconnected.

The micro texture may be a repeating ordered pattern or an irregular pattern.

During the manufacture of a folded tube for heat exchanger core, the step of imprinting a micro texture onto one surface of metal strip material of a depth ranging between 0.01 and 0.03 mm may be performed at different stages of the process.

The step of imprinting the micro texture may be carried out after unrolling the metal strip material from a coil and before folding the metal strip material into a continuous tube; after folding the metal strip material into a continuous tube but before cutting the continuous tube into individual tubes, or immediately before or during a step of imprinting winglets on the tube.

Further details and benefits of the various aspects of the present disclosure become apparent from the following description of the appended drawings. The drawings are provided herewith for purely illustrative purposes and are not intended to limit the scope of the present invention.

### BRIEF DESCRIPTION OF THE DRAWINGS

In the drawings,

FIG. 1 shows a perspective view of a prior art heat exchanger having folded tubes extending between two headers;

FIG. 2 shows a perspective view of a unitary strip of heat conductive material extending along a longitudinal axis A of FIG. 1 with a micro texture imprinted along a partial length of the strip where the strip comes into contact with cladding material;

FIG. 3 shows a perspective view of a unitary strip of heat conductive material extending along a longitudinal axis A of FIG. 1 with a micro texture imprinted along the entire length of the strip;

FIGS. 4, 5, 6, 7 and 8 show perspective views of intermediate stages in the formation of a folded tube in accordance with the disclosed method;

FIG. 9 shows a perspective view of a cross-section of a finished tube made in accordance with the disclosed method;

FIG. 10 shows a variation of the unitary strip of FIG. 2;

FIGS. 11, 12, 13, 14 and 15 show examples of texture to be applied to the unitary strips of FIG. 2, 3 or 10;

FIG. 16 shows a tube-forming device for manufacturing tubes according to the present disclosure;

FIG. 17 shows a first example of an extruded tube with an imprinted micro texture;

FIG. 18 shows a second example of an extruded tube with an imprinted micro texture; and

FIG. 19 shows a third example of an extruded tube with an imprinted micro texture.

### DETAILED DESCRIPTION OF THE DRAWINGS

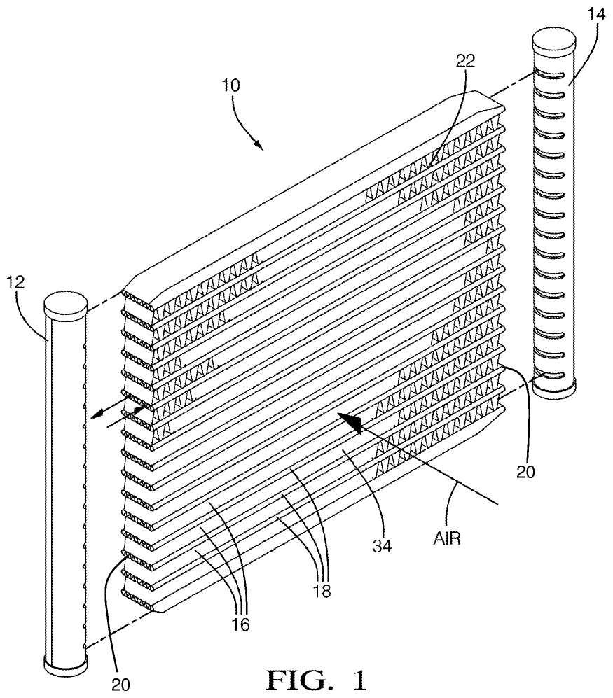

FIG. 1 is a perspective view of on example of a heat exchanger assembly 10 having a plurality of folded tubes 16 extending from a first header 12 to a second header 14. The folded tubes 16 are in fluid communication with the first and second headers 12 and 14. To establish the fluid communication, longitudinal ends 20 of the folded tubes are inserted into corresponding slots 24 formed on the headers 12 and 14. The heat exchanger assembly 10 may be that of a condenser for the condensing of a two phase refrigerant, a radiator for the dissipation of heat from a coolant that is circulated through a hot internal combustion engine, or any other heat exchanger having folded tubes 16. Any shape of the folded tubes' cross-section can be produced by providing progressive form rollers of suitable shape. The longitudinal ends 20 of the folded tubes are customarily connected to the headers 12 and 14 by a brazed joint. Air fins 18 are placed between adjacent tubes 16 for increasing the surface for heat exchange.

With braze joints between two surfaces, the best bonds are created when the surfaces are roughened as opposed to being entirely smooth. Because the headers are typically formed from stamped sheet metal, the stamping process usually leaves a residual micro texture at the surrounding slots. This micro texture serves as brazing surface. In contrast, the tubes 16 typically exhibit a smooth surface identical to the strip stock, from which they are formed. For enhancing the brazing quality between tubes 16 and headers 12 and 14, the present disclosure describes applying a micro texture to the exterior tube surface.

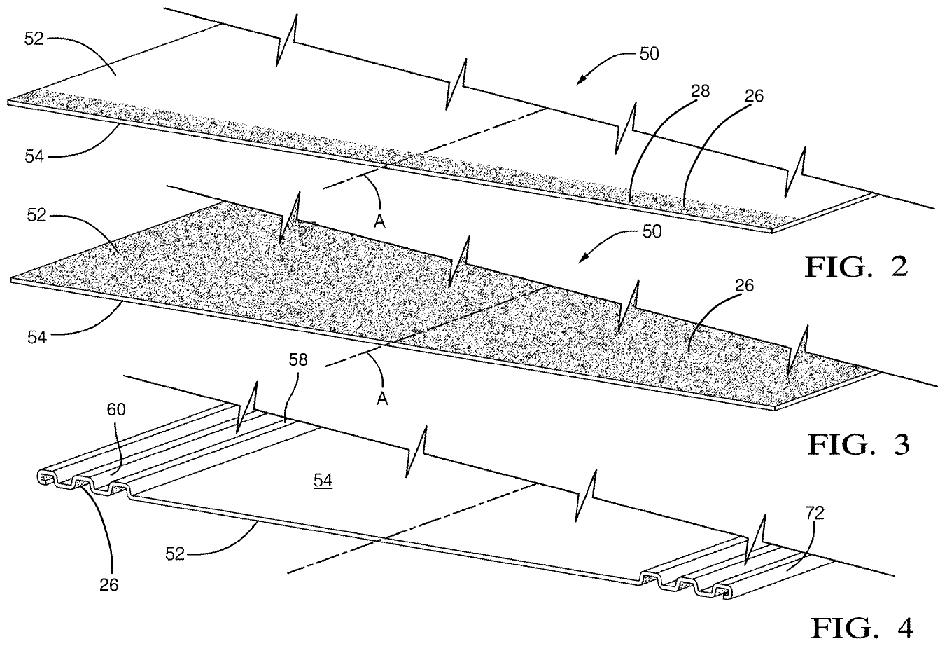

Shown in FIGS. 2 and 3 is a perspective view of an elongated strip 50 of heat conductive material, preferably a continuous clad metal strip 50 such as a clad aluminum strip, having a first surface 52 and an opposite second surface 54 extending along a longitudinal A-axis. The thickness of the clad metal strip 50 defines the minimum thickness of the outside wall of the tube 16. For example, the clad metal strip 50 may have a total thickness of 0.1 mm to 0.3 mm or even thicker, where the cladding forms about 5% to 15% of the thickness of the clad metal strip 50.

For illustrative purposes, the first surface 52 is oriented in the upward direction, and the second surface 54 is oriented in the downward direction in FIGS. 2 and 3. The cladding material covering the strip 50 has a depth of about 5% to 15% of the thickness of the aluminum. Both strips 50 of FIGS. 2 and 3 bear a micro texture 26 imprinted on the first surface 52. In one example, the micro texture 26 has a depth of 0.01 to 0.03 mm for an exemplary thickness of the aluminum of 0.2 mm and may make up between 5% and 20% of the thickness of the aluminum in other examples, where the depth of the micro texture 26 may be equal to or greater than the thickness of the cladding. For example, where the micro texture is deeper than the cladding, permanent channels are formed in the underlying material that facilitate the flow and adhesion of the melted cladding material buy a capillary effect. On the other hand, the micro texture should not penetrate so deep as the weaken the structural integrity of the finished tube 16. While appropriate brazing requires less than a 0.2 mm braze gap, the braze capability can be improved without sacrificing the maximum braze gap.

In FIG. 2, the micro texture 26 is limited to textured bands 28 along a partial length of the strip 50 and extends along the longitudinal axis A at least as far as the melted cladding material travels when the finished tube is brazed to the header. Thus, the textured bands may have a width between about 5 mm and 20 mm. In contrast, on the strip 50 of FIG. 3, the micro texture 26 extends longitudinally and laterally across the entire first surface 52. The micro texture of FIG. 3 may be helpful for brazing the fins 18 to the tubes 16 along the length of the tubes 16. In both examples, the first surface 52 will become the outer surface of the finished tube 16.

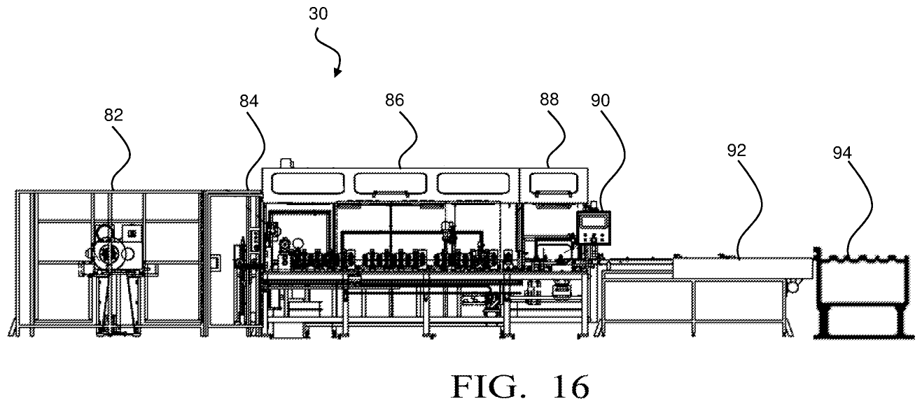

An example of a roll forming apparatus 30 suitable for transforming the strip 50 into a tube 16 is shown in FIG. 16 and will be discussed in more detail below. The strip 50 is fed longitudinally, i.e. parallel to the axis A, into the multi-station roll forming apparatus 30 to symmetrically plastically deform the strip 50 to form a corrugation 56 having an internal nose 72 on either sides of the A-axis as shown in FIG. 4. Forming the internal nose 72 as part of the corrugation 56 is optional as internal noses are not always part of a folded tube 16.

Each of the corrugations 56 defines a series of alternating crests 58 and web segments 60 joining the adjacent crests 58. On ends of the corrugations 56 is the internal nose 72 defined by an outward extension, with respect to the axis A, of the outermost crest 58 followed by an inward curve of the edge of the strip 50 back toward the axis A. The internal nose 72 includes an exterior surface formed by a portion of the smooth second surface 54.

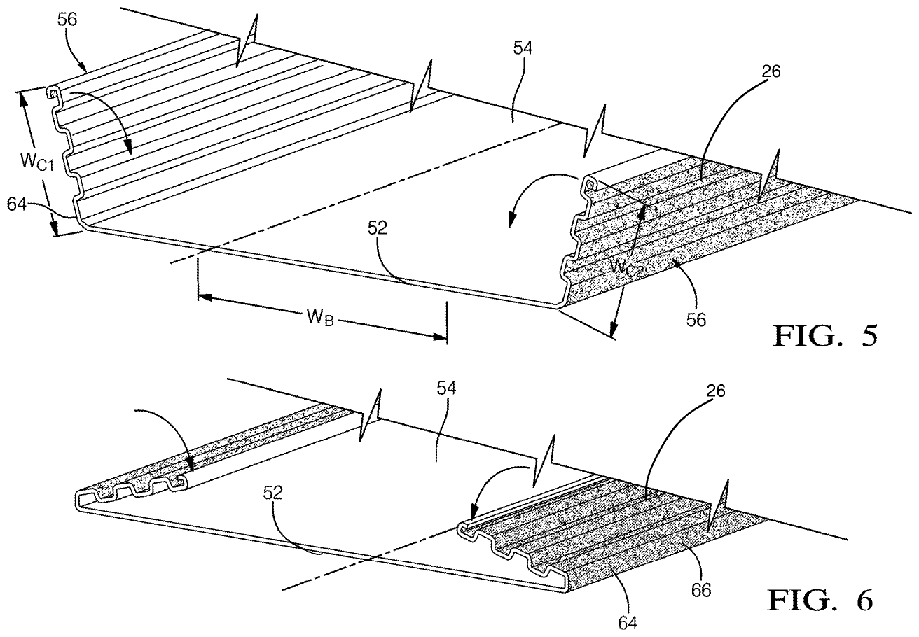

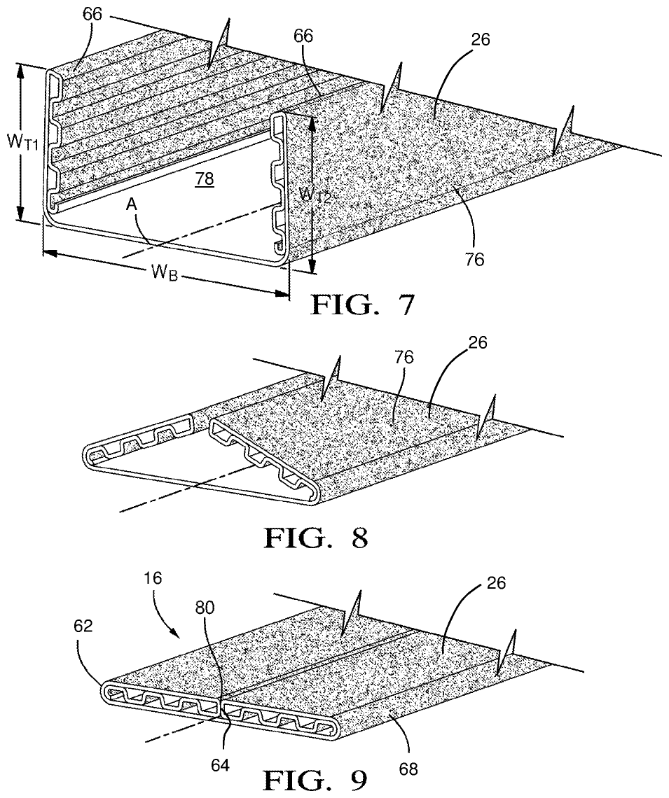

Shown in FIGS. 5 and 6, the corrugations 56 are folded inward onto the second surface 54, thereby defining a central wall 64 along the transition of the fold. The central wall 64 includes an abutting surface 66 defined by a portion of the first surface 52 along the fold. Referring to FIGS. 7 and 8, each of the folded corrugations 56, together with the portion of the strip that the corrugation 56 is folded onto, is folded again toward the second surface 54 such that the abutting surfaces 66 of the central walls 64 are tightly pressing against each other, thereby defining a “B” shape double nosed tube 16 having a pair of opposing double noses 62 if the internal noses 72 were formed. Referring to FIG. 9, the outside of the finished tube 16 is covered by the micro texture, while the smooth second surface is entirely inside the tube 16.

After tube 16 has been folded, it is cut to the desired length, assembled with the other components of the heat exchanger assembly, and brazed to form a complete heat exchanger assembly 1′0. The first surface 52 becomes the outer surface of the tube 16, and the micro texture 26 is present throughout the area of the brazing joint. Portions of the first surface 52 are inside the tube 16 if the micro texture is imprinted before folding the tube 16. This is not required as will be explained below.

FIG. 10 shows a modified example of a metal strip suited for forming a folded tube. In FIG. 10 a cutting line Z where the folded material is cut into individual tubes 16 is shown perpendicular to the longitudinal axis. The example of FIG. 10 includes so-called winglets formed in the strip material. Winglets are bumps or dimples stamped into the strip material for better flow distribution of the refrigerant. The micro-texture, if applied to the entire surface would have the potential to damage the winglets or vice versa, depending on the order of the successive manufacturing steps. Accordingly, the micro texture 26 is applied only as bands 28 in the vicinity of the cutting line that constitutes the location of the tube ends, similar to the example of FIG. 2.

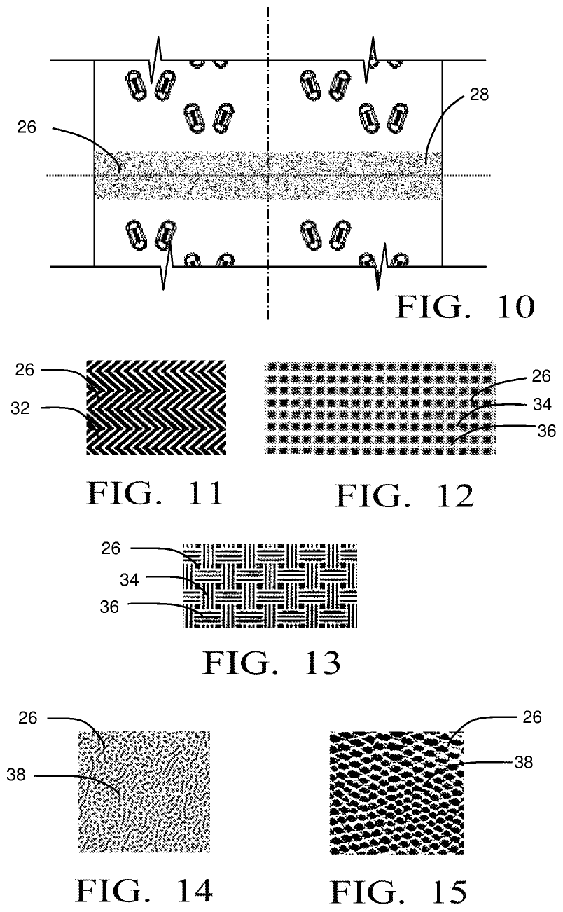

FIGS. 11 through 15 give examples of suitable micro textures 26. The examples of FIGS. 11 through 15 are shown magnified. each of the shown images covers the area of only 1 to 5 mm². Thus, the exact structures would not be discernible without magnification. In FIGS. 11 through 15, elevated areas are shown in black, and depressed areas that form channels in the surface are rendered white.

FIG. 11 shows a herringbone pattern, in which parallel channels 32 have a zigzag shape. It is preferred that the vertical direction of FIG. 11, i.e. the general direction of the channels 32, extends along the longitudinal axis A. The channels 32 create a capillary effect allowing the melted cladding material to be evenly distributed at the brazing joint without running off laterally.

FIG. 12 shows an inverted waffle pattern (i.e. analog to the profile of a waffle iron), where parallel longitudinal channels 34 cross parallel lateral channels 36. Thus, all channels 34 and 36 are interconnected and thus provide capillary flow paths for the melted cladding material. These interconnected channels allow for a distribution of the melted cladding material longitudinally and laterally, while the capillary adhesion avoids excessive accumulation that would lead to a run-off of the cladding material.

The pattern shown in FIG. 13 likewise includes longitudinal channels 34 and lateral channels 36. These channels, however, are arranged in a braid-like pattern so that the channels are shortened. A plurality of parallel longitudinal channels 34, in this example four longitudinal channels, extend from a plurality of lateral channels to the next plurality of lateral channels 36, and vice versa. This pattern creates a meandering path for the cladding material that allows distribution of the material while reducing run-off or local accumulation. The flow of the cladding material is slowed down, and the cladding material will cover a large contact surface while propagating through the winding path.

While FIGS. 11 through 13 show repeating ordered patterns, FIGS. 14 and 15 show two examples of random patterns that provide similar benefits as the pattern of FIG. 13 because they feature curved channels 38 that don't allow a straight flow path of the melted cladding material. In FIG. 13, randomly distributed ridges of varying length, curvature, and orientation create curved channels in the interstitial spaces. In FIG. 14, a pebbled structure, similar to an irregular inverse honeycomb pattern, provides a similar effect.

The width of the channels 32, 34, 36, and 38 is in the order of 0.02 mm to 0.05 mm, where the channels typically have a width greater than their depth. It is evident that various other ordered an unordered patterns would be suitable for the micro texture 26. Preferred are such structures that provide for a controlled distribution of melted cladding material via channels and also create a roughness to the surface of the tube that prevents run-off away from the brazing joint.

FIG. 16 is a schematic illustration of a roll forming apparatus 30 for the manufacture of folded tubes 16. The roll-forming apparatus 30 includes a sequence of stations 82-94, each station performing a different manufacturing step. The strip 50 is fed into a decoiler 82, where the strip 50 is unrolled from a coil, which is the shape, in which the strip material is stored. After being lubricated in an oiling station 84, the strip is formed into a continuous tube in a forming station. 86. Subsequently, the continuous tube is cleaned in a fluxing station 88 and calibrated in a calibration station 90 for cutting. In a cutting station 92, the continuous tube is then cut into individual tubes of a given length that are packed up in a packing station 94 for further quality testing.

The micro-texture may be applied at different stages of the manufacturing process. Where the entire surface of the strip 50 is covered with the micro texture 26, the micro texture 26 may be imprinted immediately after being decoiled, prior to shaping the strip into tubes, i.e. prior to reaching the forming station 86. One of the rolls feeding the strip into the oiling station may have the inverse pattern of the micro texture 26 that can be impressed onto the desired surface of the strip 50 by roll pressure. The micro texture 26 can be imprinted into the strip 50 without affecting the overall material strip stock thickness, although it is possible there will be a minimal material width increase that may be considered by feeding a slightly narrower strip in to the roll forming apparatus than customary for unfeatured tubes.

For tubes with winglets as shown in FIG. 10, the micro texture 26 may be imprinted simultaneously with stamping the winglets in the forming station. For other tubes, for example with a micro texture 26 only near the tube ends, the micro texture 26 may be imprinted after the tube has been folded, e.g. during calibration, when it is known where the continuous tube will be cut. Accordingly, the flat strip 50 does not necessarily have a micro texture 26 as shown in FIG. 2 because the micro texture 26 is only applied after forming the tube 16.

The final quality control may apply various criteria via visual inspection, or measurements by a profilometer or a blue-light scanner. Applicable standards may be found in ISO 25178 dealing with Geometric Product Specifications (GPS)—Surface Texture: Areal.

Improved braze from textured surfaces will not only affect tube-to-header joints but potentially also tube-to-fin joints if applied across the entire mating surface as shown in FIG. 3. The shallow depth of the texture is not likely to increase the tubes' heat rejection capability nor is it likely to increase an air side pressure drop on a macroscopic scale as any increase in turbulences will be very minor due to the small depth of the micro texture 26.

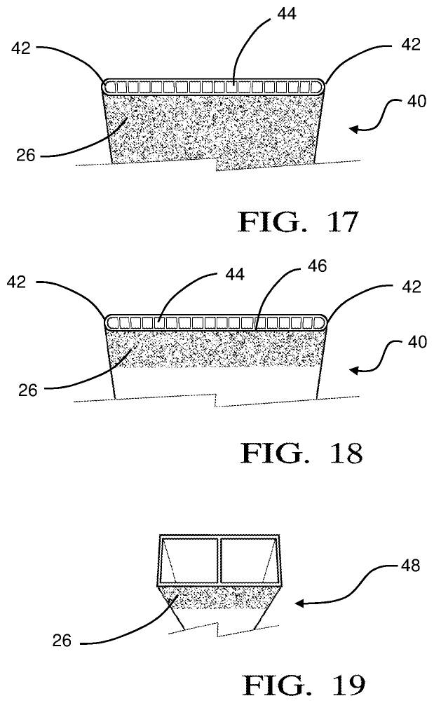

FIGS. 17 through 19 show the concept of applying the micro texture 26 to extruded tubes. In FIGS. 17 and 18, the extruded tube 40 is shaped as a flat tube with rounded leading and trailing edges 42, similar to the folded tube 16 of FIG. 9. The extruded tube 40, however, is extruded in its final profile with preformed micro channels 44 extending through the length of the tube 40. In the example of FIG. 17, the micro texture 26 is imprinted on the outside surface of the tube 40 along the entire length of the tube 40, while in FIG. 18, the micro texture is imprinted only in the vicinity of the tube end 46. As mentioned above, covering the entire tube length promotes an improved brazing connection between the tube 40 and the fins arranged between adjacent tubes 40.

FIG. 19 shows an alternative profile of an extruded tube 48 with a rectangular cross-section. Here, the micro texture is applied on all four sides of the outer surface of the tube 48.

Extruded tubes may have a varying material thickness. They may, for example, have thicker outside walls at leading or trailing edges, to improve the strength on the outer sidewall in locations of potential impact from debris. In such tubes, the micro texture has a depth of about 5% to 20% of the thinnest portions of the outside walls. Extruded tubes typically find use in condensers.

While the above description constitutes the preferred embodiments of the present invention, it will be appreciated that the invention is susceptible to modification, variation and change without departing from the proper scope and fair meaning of the accompanying claims.

What is claimed is:

1. A tube for a heat exchanger core, the tube comprising an outside wall defining a minimum wall thickness and having a micro texture imprinted on an outer surface of the outside wall, the micro texture having depth between 5% and 20% of the wall thickness.

2. The tube according to claim 1, wherein the tube is made of cladded metal strip material.

3. The tube according to claim 1, wherein the tube is an extruded tube.

4. The tube according to claim 1, wherein the tube is folded from metal strip material and an entire strip surface is covered with the micro texture so that micro texture is present on the outer surface of tube and inside tube.

5. The tube according to claim 1, wherein the micro texture is imprinted after forming the tube, and the micro texture is only present on the outer surface of the tube.

6. The tube according to claim 1, wherein the micro texture is only present in textured bands proximate the ends of the tube within 10 mm of tube ends, with central portion between texture bands being free of micro texture.

7. The tube according to claim 1, wherein the tube has winglets between textured bands.

8. The tube according to claim 1, wherein the micro texture is an imprinted pattern forming capillary channels.

9. The tube according to claim 8, wherein the capillary channels are interconnected.

10. The tube according to claim 8, wherein the micro texture is a repeating ordered pattern.

11. The tube according to claim 8, wherein the micro texture is an irregular pattern.

12. A method of manufacturing a folded tube for heat exchanger core, the method comprising the step of imprinting a micro texture onto one surface of metal strip material, the micro texture having a depth ranging between 0.01 and 0.03 mm.

13. The method according to claim 12, wherein the step of imprinting the micro texture is carried out after unrolling the metal strip material from a coil and before folding the metal strip material into a continuous tube.

14. The method according to claim 12, wherein the step of imprinting the micro texture is carried out after folding the metal strip material into a continuous tube and before cutting the continuous tube into individual tubes.

15. The method according to claim 12, wherein the step of imprinting the micro texture is carried out immediately before or during a step of imprinting winglets on the tube.

16. The method according to claim 12, wherein the micro texture is an imprinted pattern forming capillary channels.

17. The method according to claim 16, wherein the capillary channels are interconnected.

18. The method according to claim 16, wherein the micro texture is a repeating ordered pattern.

19. The method according to claim 16, wherein the micro texture is an irregular pattern.
